(19) United States
(12) Patent Application Publication
(10) Pub. No.: US 2014/0365208 A1
(43) Pub. Date: Dec. 11, 2014

(54) CLASSIFICATION OF AFFECTIVE STATES IN SOCIAL MEDIA

(71) Applicant: Microsoft Corporation, Redmond, WA (US)

(72) Inventors: Munmun De Choudhury, Bellevue, WA (US); Michael Gamon, Seattle, WA (US); Scott Counts, Seattle, WA (US)

(21) Appl. No.: 13/918,709

(22) Filed: Jun. 14, 2013

Related U.S. Application Data
(60) Provisional application No. 61/831,139, filed on Jun. 5, 2013.

(51) Int. Cl. G06F 17/27

(52) U.S. Cl. CPC G06F 17/2765
USPC 704/9

(57) ABSTRACT

Affective state classification embodiments are described which train and use a classifier to identify an affect exhibited by a segment of text. The affect being identified is chosen from a group of affects, each of which corresponds to a different emotion or sentiment being expressed by a person authoring the segment of text. In addition, each affect in the group of affects relates more than the valence of the emotion or sentiment being expressed. In other word, the identified affect is more than just an indication of the positive or negative nature of the text segment. Rather, in one embodiment, the classifier is trained to identify whether a segment of text exhibits one of the following affects: fear, sadness, guilt, hostility, joviality, self-assurance, attentiveness, shyness, fatigue, surprise, and serenity.

### CROSS REFERENCE TO RELATED APPLICATION

This application claims the benefit of and priority to provisional U.S. patent application Ser. No. 61/831,139 filed Jun. 5, 2013.

### BACKGROUND

Emotional states of individuals, also known as moods, are central to the expression of thoughts, ideas and opinions, and in turn impact attitudes and behavior. Human emotions and mood have been a well-studied research area in psychology. Generally speaking, moods are complex patterns of cognitive processes, physiological arousal, and behavioral reactions. Moods serve a variety of purposes. They rouse us to action and direct and sustain that action. They help us organize our experience by directing attention, and by influencing our perceptions of self, others, and our interpretation and memory of events. By intensifying experiences, moods help identify self-relevant events. In other words, moods play a critical role in our everyday lives, fundamentally directing our attention and responses to environment, framing our attitudes and impacting our social relationships.

Considerable research in psychology has defined and examined human emotion and mood, with basic moods encompassing positive experiences like joy and acceptance, negative experiences like anger and disgust, and others like anticipation that are less clearly positive or negative. Of notable importance is the role of intensity or activation in emotion and mood, defined as the psychophysiological arousal of the mood in response to an associated stimulus. Together with valence (i.e., the degree of positivity/negativity of a mood), these two attributes characterize the structure of affective experience.

Given the important role of moods in human behavior, a growing body of literature has emerged in the social network/media research community that aims to mine temporal and semantic trends of affect, or detect and classify sentiment in order to better understand polarity of human opinions on various topics and contexts. This is understandable as social media tools (such as Twitter™) continue to evolve as major platforms of human expression, allowing individuals across the globe to share their thoughts, ideas, opinions and events of interest with others. While such content sharing can be objective in nature, it can also reflect emotional states from personal (e.g., loneliness, depression) to global scales (e.g., thoughts about a political candidate, musings about a newly released product or the global economy). Understanding these emotional states, or moods, of individuals at a large scale, manifested via their shared content on social media will help better interpret and make sense of the behavior of millions of individuals.

The aforementioned social network research has been largely directed towards automatic classification of sentiment in online domains. Typically, machine learning techniques are employed in an attempt to label text as being in one of two broad, general categories—namely either text exhibiting a Positive Affect (PA) or text exhibiting a Negative Affect (NA).

### SUMMARY

Affective state classification embodiments described herein generally involve the training and use of a classifier which identifies an affect exhibited by a segment of text. In an exemplary embodiment of the classifier training, a plurality of segments of text, each of which exhibits a known affect, is input into a computing device. For each of these, features are extracted from the segment to produce a vector of word features. The word feature vectors are then employed to train a classifier to identify an affect exhibited by a later-input text segment. It is noted that the affect being identified is chosen from a group of affects, each of which corresponds to a different emotion or sentiment being expressed by a person authoring the segment of text. In addition, each affect relates more than just the valence of the emotion or sentiment being expressed.

As indicated above, once the classifier is trained, in an exemplary embodiment it is used to classify an affect exhibited by a segment of text. This generally involves using a computing device to input the trained classifier, as well as a segment of text. The trained classifier is then used to identify an affect exhibited by the inputted segment of text. The affect being identified is chosen from the aforementioned group of affects.

It is noted that this Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

The specific features, aspects, and advantages of the disclosure will become better understood with regard to the following description, appended claims, and accompanying drawings where:

FIGS. 1A-B is a table listing mood words, along with their valence and activation values, and their affects.

FIG. 2 is a table listing associations of a sample of moods to five affects.

FIG. 3 is a table listing the number of moods associated with the affects.

FIG. 4 is a diagram depicting an exemplary computing program architecture for implementing the training of a classifier to identify an affect exhibited by a segment of text.

FIG. 5 is a flow diagram generally outlining one embodiment of a process for training of a classifier to identify an affect exhibited by a segment of text.

FIG. 6 is a flow diagram generally outlining one embodiment of a process for determining if a segment of text exhibits an affect when the text segment is a social media text segment having a hashtag that includes a mood word.

FIG. 7 is a flow diagram generally outlining one embodiment of a process for reducing the number of word features across the feature-extracted text segments.

FIG. 8 is a diagram depicting an exemplary computing program architecture for implementing the classification of affects in segments of text.

FIG. 9 is a flow diagram generally outlining one embodiment of a process for classifying affects in segments of text.

FIG. 10 is a diagram depicting a general purpose computing device constituting an exemplary system for implementing affective state classification embodiments described herein.

### DETAILED DESCRIPTION

In the following description of affective state classification embodiments reference is made to the accompanying drawings which form a part hereof, and in which are shown, by way of illustration, specific embodiments in which the technique may be practiced. It is understood that other embodiments may be utilized and structural changes may be made without departing from the scope of the technique.

It is also noted that for the sake of clarity specific terminology will be resorted to in describing the affective state classification embodiments described herein and it is not intended for these embodiments to be limited to the specific terms so chosen. Furthermore, it is to be understood that each specific term includes all its technical equivalents that operate in a broadly similar manner to achieve a similar purpose. Reference herein to “one embodiment”, or “another embodiment”, or an “exemplary embodiment”, or an “alternate embodiment”, or “one implementation”, or “another implementation”, or an “exemplary implementation”, or an “alternate implementation” means that a particular feature, a particular structure, or particular characteristics described in connection with the embodiment or implementation can be included in at least one embodiment of the affective state classification. The appearances of the phrases “in one embodiment”, “in another embodiment”, “in an exemplary embodiment”, “in an alternate embodiment”, “in one tested embodiment”, “in one implementation”, “in another implementation”, “in an exemplary implementation”, “in an alternate implementation” in various places in the specification are not necessarily all referring to the same embodiment or implementation, nor are separate or alternative embodiments/implementations mutually exclusive of other embodiments/implementations. Yet furthermore, the order of process flow representing one or more embodiments or implementations of the affective state classification does not inherently indicate any particular order nor imply any limitations of the technique.

### 1.0 Affective State Classification

As indicated previously, social media tools have been gaining significant traction of late in emerging as platforms of human sentiment and affect expression. Sentiment and affect analysis can be useful in a number of scenarios, including marketing campaigns, monitoring responses to local and global happenings, and deciphering geographic and temporal mood trends. As social media tools become increasingly ubiquitous, such analyses of affect can also enable new information-seeking approaches; for instance, identifying search features given an affect attribute. Consequently, there is significant value to be derived from predicting and classifying human affect in social media.

To this end, the affective state classification embodiments described herein generally classify several human affective states in segments of text and in some embodiments classify affects in segments of social media text (e.g. social media posts). Starting with about 200 moods (as will be described in more detail later), mechanical turk studies are used to derive naturalistic signals from posts shared on social media about a variety of affects of individuals. This dataset is then deployed in an affect classification task.

However, classifying affective states in social media domains has several challenges. First, the variety of linguistic styles and emotional interpretations of millions of individuals impedes inferring affective states concretely; and at the same time constructing consistent features across shared content is challenging. Second, most standard machine learning techniques rely on availability of labeled data for training. Manual labeling of ground truth is possible and can be employed. However, an alternate method of gathering appropriate training examples is also available involving explicit mood words used as hashtags at the end of some social media posts.

More particularly, some affective state classification embodiments described herein generally employ an affect classifier of social media data that uses about 200 mood hashtags as a supervision ground truth signal for inferring affect. These explicit hashtag mood words are mapped to a number of affective states. In one embodiment, 11 different affective states of individuals are employed (as will be described in more detail later). The aforementioned mapping is derived via a series of mechanical turk studies. The affect-labeled posts are then used in a maximum entropy classification framework to predict the affective state, given a post.

Note that the affective state classification embodiments described herein go well beyond the standard Positive Affect (PA)/Negative Affect (NA) classification schemes (or “positive”, “negative” and “neutral” schemes). Thus, the described embodiments have the advantage of providing a rich classification framework that captures important nuances in mood expression.

However, before a more detailed description of the affective state classification embodiments is presented, it would be useful to understand how the expression of moods is associated with the behavior of individuals, e.g., their linguistic usage of moods, social ties, activity levels, interaction patterns and so on. As described previously, moods impact human behavior, responses to environmental stimuli, and social ties. Naturally, it is imperative to understand characteristics of moods on social media in order to decipher the collective behavior of large populations.

To this end, the first sections presented below will discuss the identification and study a variety of moods that frequent social media posts. The dimensions of valence and activation are employed to represent moods in the circumplex model, and the topology of this space is studied with respect to mood usage, network structure, activity, and participatory patterns. It is through this study that the aforementioned approximately 200 moods frequently found in social media are identified. In addition, these moods are analyzed in the context of behavioral attributes that define an individual's actions in social media, including mood usage levels, linguistic diversity of shared content, network structure, activity rates and participatory patterns (e.g., link sharing and conversational engagement).

### 1.1 Identifying Social Media Moods

Identifying social media moods begins with identifying representative mood words, i.e., signals that would indicate individuals' broad emotional states. These moods are then characterized by the two dimensions of valence and activation.

### 1.1.1 Mechanical Turk Study for Mood Identification

A large number of potential mood words were first pooled from a variety of sources. While these words bore the notion of positive/negative feelings, not all of them were appropriate as mood words. For example, “pretty” and “peace” both represent a positive affect, but are not convincingly moods. Hence, a filtering task was performed to identify mood-indicative words from the candidate list.

This filtering task progressed in two parallel phases. In one phase, two researchers (both fluent English speakers) were asked to rate each of these words on a Likert scale of 1-7, where 1 indicated “not a mood at all” and 7 indicated “absolutely a mood”. This resulted in a set of high quality base-line ratings. In the other parallel phase, a similar mood-rating collection task was set up using the framework provided by Amazon's Mechanical Turk (AMT) interface (http://aws.amazon.com/mturk/). AMT is a crowd sourcing Internet marketplace where a requester can co-ordinate the use of human intelligence to perform tasks. Like the researchers, the “turkers” were asked to rate the words on the 1-7 Liked scale. Each word was rated by 12 turkers, and only those turkers who had a greater than 95% approval rating and were from the United States were considered.

Using the ratings from the turkers and the researchers, a list was constructed of all those words where both the median turk rating and the median researcher rating was at least 4 (mid-point of the scale), and the standard deviation was less than or equal to 1. This gave a final set of 203 mood words that were agreed upon by both parties to be mood-indicative (examples include: excited, nervous, quiet, grumpy, depressed, patient, thankful, bored).

### 1.1.2 Valence and Activation

As indicated previously, the mood words can be characterized by the dimensions of valence and activation. Valence represents the degree of positivity/negativity of a mood, and activation represents the degree of psychophysiological arousal of the mood in response to an associated stimulus (with some emotions being more arousing than others). For example, depressed is higher in arousal than sad. Together valence and activation characterize the structure of affective experience, and their inter-relatedness aids in conceptualizing the affect.

### 1.1.3 Inferring Mood Valence and Activation Values

Given the aforementioned list of representative moods, the next task is to determine the values of the valence and activation dimensions of each mood. For some words in the list, these mood attributes are conventionally known, having been computed after extensive and rigorous psychometric studies. As such these known mood attribute values can be adopted.

For the remaining words, another turk study was conducted. Like before, only those turkers who had at least 95% approval rating history and were from U.S. were considered. For a given mood word, each turker was asked to rate the valence and activation measures, on two different 1-10 Likert scales (1 indicated low valence/low activation, while 10 indicated high valence/high activation). The choice of this Likert scale was made to align with the scales used for words with the aforementioned adopted valence and activation values. Twenty-four ratings were collected per mood—12 each for valence and activation. Finally, for each mood, the ratings valence and activation were combined separately. In one embodiment, the mean ratings were employed as the final measures for the two attributes.

### 1.2 Circumplex Model

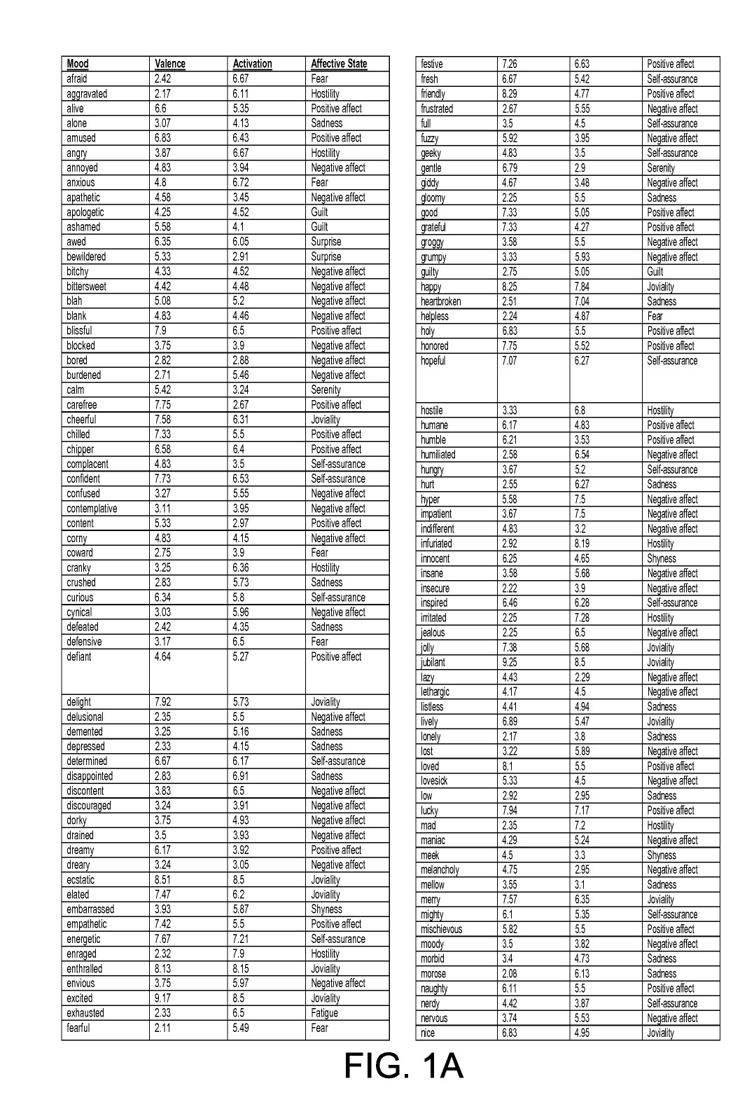

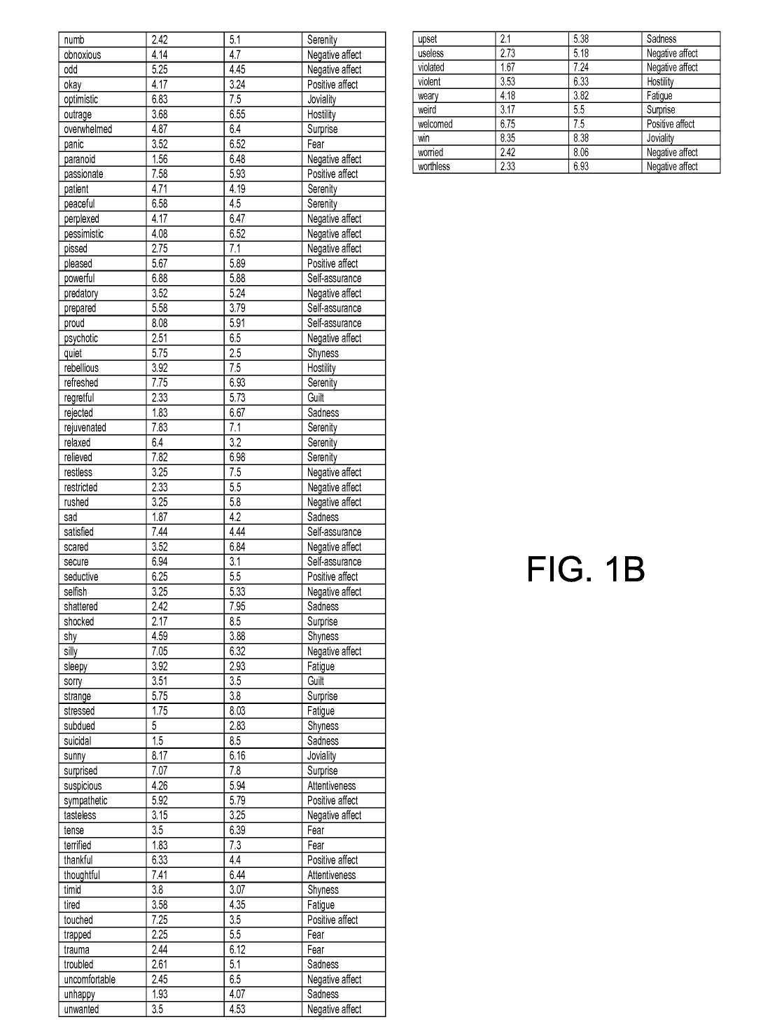

The outcome of the foregoing studies was a set of 203 mood words, with each word characterized by both valence and activation values. FIGS. 1A-B depict a table listing these mood words and their attribute values. Note that the last column in the table in FIGS. 1A-B provides the affective state assigned to each mood word. These affective states will be described in more detail shortly.

A popular representation of moods is the circumplex model, which represents moods in 2-dimensional topology defined by valence (x-axis) and activation (y-axis). It is a spatial model in which affective concepts fall in a circle. When the aforementioned mood words are plotted using the circumplex model by their mean valence (x-axis) and mean activation (y-axis) ratings, several features of the resulting space are noteworthy. First, the number of different mood words are fairly equally distributed in the four quadrants Q1-Q4. Second, while the valence ratings cover almost the entire range between 1 and 10, there are fewer mood words with very high activation or very low activation, compared to valence. Also note that words of neutral valence (e.g., quiet) tend to be of lower activation. This is reasonable, as typically more extreme moods (e.g., infuriated) generate higher activation. Overall this circumplex model provides a fine-grained psychometric instrument for study of mood expression in social media.

### 1.3 Collecting Labeled Mood Data

In one tested embodiment, mood data was collected from the popular social media Twitter™. Because of its widespread use, Twitter™ can be seen as a large and reliable repository for observing the rich ensemble of moods. Mood data was collected on a full year's worth of Twitter™ posts posted in English. Since there were a considerable volume of posts that does not reflect moods, the first task was to eliminate as many non-mood-indicative posts as possible, while simultaneously avoiding labor-intensive manual labeling of posts with moods.

To tackle this challenge, it was observed that Twitter™ users share posts with hashtagged moods, often with the hashtag at the end of the post, which can serve as labels for constructing a mood dataset. For example, the hashtagged mood “#excited” is found in many posts. In this light, hashtags were used as labels to train classifiers (as will be described in more detail later). Posts which have one of the moods found the aforementioned 203 mood word lexicon in the form of a hashtag at the end of a post, were collected. By this process, the labeled mood dataset comprised about 10.6 million posts from about 4.1 million users. Finally, RT (“retweet”) posts were eliminated because there may be cases where a mood hashtag is added at the end to comment on the retweet—which is arguably different from the author associating a mood with the language they produce.

### 1.4 Verifying Quality of Mood Data

The collection of hashtag labeled data on moods can be relatively easy since it avoids manual annotations or computationally intensive machine learning, but how reliable is it to consider mood hashtags at the end of posts as true indicators of an individual's emotional state? To answer this question, responses were first gathered from a set of users via a turk study. The study intended to determine for how many cases a hashtagged mood word occurring at the end of a post truly captures an individual's mood (without the presence of external signals). Specifically, a Yes/No question was displayed alongside a post, to which the turker indicated whether the (highlighted) mood hashtag at the end of the post indeed reflected the author's sentiment. Like before, only U.S. turkers with greater than 95% approval rating history were considered. In addition, a requirement that the turker had to use Twitter™ at least five times a week was added (consuming content).

Separately, the quality of the mood data was also compared to a naïve method of spotting mood words anywhere in a post. Like before, a turk approach was used to determine for how many cases a mood word present anywhere in a post indicated the author's sentiment. For both the studies, this exercise was conducted over 100 posts per study, and each post was rated by 10 different turkers.

The studies indicated that in 83% of the cases, hashtagged moods at the end of posts indeed captured the users' moods; while for posts with moods present anywhere, only 58% captured the emotional states of the corresponding users (Fleiss-Kappa measures of inter-rater agreement for both studies were 0.68 and 0.64 respectively), thus providing a systematic verification of the quality of the labeled mood dataset.

### 1.5 Mapping Affect to Mood Words

Affect refers to the experience of feeling or emotion and is a key part of the process of an individual's interaction with environmental stimuli. The primary challenge in classifying affect lies in the unavailability of ground truth. The psychology literature indicates that there is an implicit relationship between the externally observed affect and the internal mood of an individual. When affect is detected by an individual (e.g., smile as an expression of joviality), it is characterized as an emotion or mood.

In this section, it is described how the previously-described mood word lexicon is mapped to a set of affective states. First, the set of affective states is defined. For this purpose, a version of the Positive and Negative Affect Schedule (PANAS) known as PANAS-X is adopted. PANAS-X defines 11 specific affects—namely “fear”, “sadness”, “guilt”, “hostility”, “joviality”, “self-assurance”, “attentiveness”, “shyness”, “fatigue”, “surprise”, and “serenity”. These 11 affects are employed in the classification process to be described shortly.

PANAS-X also includes a mapping of some mood words to particular affects. Approximately 60% of the aforementioned mood word lexicon can be mapped to affects based on the PANAS-X listings. A turk study was undertaken to establish mappings between some of the remaining mood words and the 11 affects. In this study, each turker was shown a set of 10 mood words and the set of 11 affects were listed with each. The turker was asked to select from the list the most appropriate affect that described the particular mood. Twelve ratings were collected per mood. Finally, the ratings for each mood word were combined, and for each word, the affect that received a majority rating was associated with the mood word. In one tested embodiment, the foregoing resulted in a mapping of 112 of the 203 mood words to an affect, where each mood word corresponded to one type of affect. FIGS. 1A-B depict a table listing these mood words and, for the words having a mapping, their associated affect. It is noted that for those mood words not having a mapping to an affect in FIGS. 1A-B, a more generic listing of whether the word has a positive or negative affect is listed. Further it is noted that while tested embodiments of the affective state classification embodiments described herein included 203 mood word and 112 mood word-to-affect mappings, it is not intended that the affective state classification embodiments be limited to just these numbers. In particular, more or fewer mood words, and more or fewer mappings, could be established. Still further, note that for the sake of simplicity, it tested embodiments a mood could be associated with only one affect. However, this need not be the case.

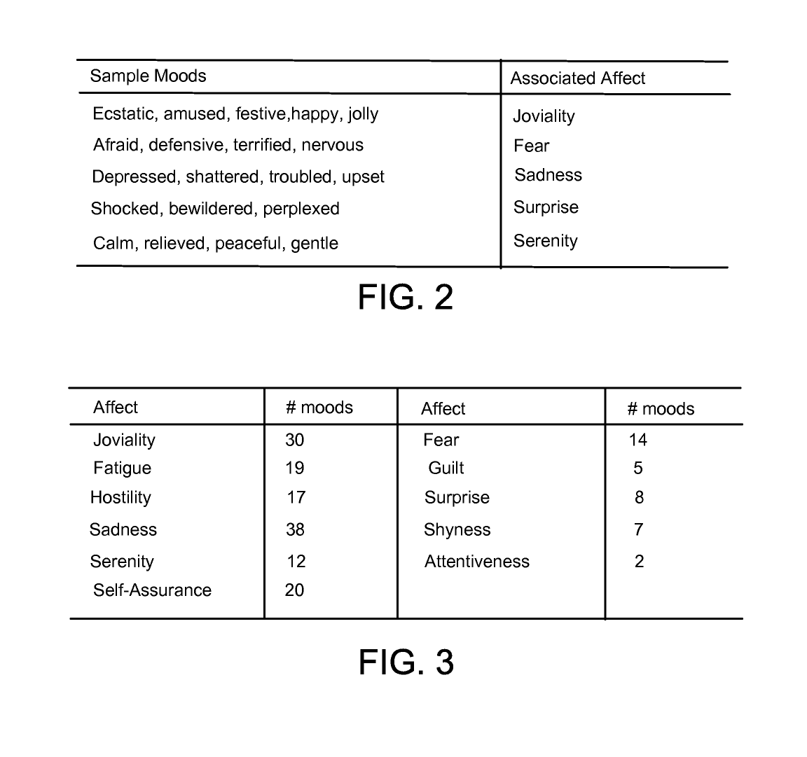

Two additional tables are also presented herein to provide a different perspective on the mood word-to-affect mappings. FIG. 2 is a table listing associations of a sample of moods to five affects, and the distribution of number of moods over affects is shown in the table of FIG. 3.

### 1.6 Usage Analytics of Moods

The first study of mood exploration on social media post data is based on analyzing the circumplex model of moods in terms of the moods' usage frequencies (counts over all posts). It is noted that the usages of moods in each of the quadrants is considerably different (the differences between each pair of quadrants were found to be statistically significant based on independent sample t-tests: p<0.0001). The overall trend is that moods in Q3 (low valence, low activation) tend to be used extensively (sad, bored, annoyed, lazy), along with a small number of moods in Q1, of relatively higher valence and activation (happy, optimistic). Overall, usage frequencies of lower valence moods exceed those of higher valence moods.

It is hypothesized that the presence of a “broadcasting bias” lies behind these observations. Since individuals often use Twitter™ to broadcast their opinions and feelings on various topics, it is likely that the mood about some information needs to be of sufficiently low or high valence to be worth reporting to the audience. This appears to be particularly true with respect to positive valence terms, with mildly positive moods expressed only rarely. The observation that lower valence moods are shared more often might be due to individuals seeking social support from their audiences in response to various happenings externally as well as in their own lives. The observation that lower activation words dominate usage of these lower valence moods could reflect the simple fact that people experience these moods more than their high activation counterparts (people are bored more frequently than they are infuriated) or that it is less acceptable to express extreme negative moods.

Also explored was how the linguistic content associated with usage of various moods relates to their valence and activation. A circumplex model was employed to plot a mood's normalized entropy, defined as the entropy of the textual content (i.e., unigrams (which in one embodiment represent single words) over all posts associated with the mood), divided by the total number of posts expressing the mood. It is observed that moods on the right side of the circumplex model (Q1, Q4) tend to have higher entropy than left (Q2, Q3) (statistically significant based on an independent sample t-test). This indicates that while positive moods tend to be shared across a wide array of linguistic context (topics, events etc.), negative moods tend to be shared in a limited context, confined to limited topics.

### 1.7 Sociality and Moods

In the next study, it was intended to investigate the relationship between the nature of moods expressed and how “social” an individual is, referred to as “sociality”. For the purposes of this description, sociality is defined as the ratio of the number of followers (inlinks) to the number of followees (outlinks) of an individual. It is assumed that individuals with a ratio close to 1 would be the most “social” since this implies roughly equal engagement on the part of those individuals in both outgoing and incoming social and information exchanges. When the ratio is significantly less than 1, it may indicate that the individual is not interesting enough to others and thereby possibly less “social” to the social media audience. On the other hand a high ratio much greater than 1 indicates that the individual is likely an elite user (e.g., a celebrity or news source) who typically is more of a broadcaster and thus also is not very “social” in the context of the social media. Nevertheless, it is noted that this measure of sociality does not incorporate the absolute number of followers and followees (i.e., two people with sociality ratios of 20/20 and 2000/2000 respectively would be considered equally ‘social’). This is acceptable as the sociality of an individual is likely to be a function of the #followers and #followees together, since they define the structure of his/her ego-network. Hence the ratio is more appropriate than the absolute values. However, other network-centric measures could be used to study the relationship between followers and followees as desired (e.g., clustering coefficient methods).

Here again, the circumplex model was used to represent relationship between moods and sociality. Each mood plotted was represented by a color square, indicating the mean #followers/#followees ratio of individuals who shared the mood. A red square denoted a low #followers/#followees ratio of the individuals who shared the mood, while blue denoted a high #followers/#followees ratio: both indicating that the individuals who share these moods are not very “social” according to the foregoing definition. Moods represented by green squares were the most “social”, with ratios of #followers/#followees close to 1. Moods of higher valence (Q1, Q4) tend to be green squares, indicating that the average individual sharing them has a #followers/#followees ratio close to 1—in other words is more “social”. On the other hand, moods of lower valence (Q2, Q3) are consistently red, i.e., individuals sharing them are not very “social”. In addition, blue square users are comparatively infrequent and tend to use moods from all quadrants. To the extent that these users are elite users, this indicates that, most times, they are reporting information on various events/topics in a rather objective and ‘mood-balanced’ manner. It is noted that to formalize these differences, the #followers/#followees ratios associated with all moods in Q1 through Q4 were compared using independent sample t-tests and the results were statistically significant: p<0.001.

These results indicate a relationship between the ego-network of individuals (i.e., the way they connect to others) and the expression of moods. While these results do show that there is positive correlation between one being more “social” and expressing moods of higher valence, they do not establish a causal relationship in any direction. The results, however, do indicate that positive moods appear to be associated with social interactions.

### 1.8 Activity Level and Moods

Next the relationship between an individual's activity and his/her mood expression is investigated. A measurement of how “active” s/he is in sharing posts is defined as: the number of posts shared per second since the time of the individual's account creation. It is conjectured that a highly active individual is likely to be more “social” as well, since s/he is interested in dissipating information to his/her audience consistently, and thereby remains connected to them.

Based on this definition, the circumplex model of moods represented by squares whose size is proportional to the mean rate of activity of all individuals who have shared the particular mood. The majority of the larger squares (or moods shared by highly “active” individuals) were found to lie in Q1 and Q4; in other words, high (or positive) valence moods are shared by highly active individuals (statistically significant based on independent sample t-tests between quadrant pairs). On the other hand, moods of high activation (in Q2) but low valence are shared primarily by individuals with a low activity rate. In general, this indicates that positive moods are associated more frequently with active individuals, while negative and high arousal moods appear to be shared more frequently by individuals with low activity. Interestingly, when combined with the previously described usage frequencies, this implies that a “tail” of users post relatively infrequently and express the bulk of the mildly negative moods (e.g., bored, lazy, annoyed, sad).

### 1.9 Participatory Patterns and Moods

In the next study, two types of participatory patterns of individuals are examined in relation to expression of mood: sharing of (external) information via links, and conversational engagement of one individual with another via the “@-reply” feature in social media posts.

The interest lies in investigating how mood expression and participation interact in the context of external information sharing and conversational engagement, compared to similar contexts where moods are not shared. To this end, the “background probabilities” of link sharing (pli) and @-replies (prp) are computed, given as ratio of #links (or @-replies) in posts to the total number of posts. Thereafter, for each mood, the probability of the mood's co-occurrence in a post along with, first a link, and second a @-reply, is computed. A distribution of the number of moods that have occurrence probabilities less than or equal to the background probability, and those greater than the background probability (of links, @-replies), is then computed. Frequency histograms of the distributions are plotted against mood valence and activation. This shows that highly negative moods (low valence) tend to co-occur less frequently with a link or a @-reply, compared to the respective background probabilities. On the other hand, several highly positive moods (higher valence) co-occur more frequently than usual with a link. This is likely to indicate that when individuals choose to express moods in a link-bearing post, it is more frequently a positive than a negative mood. In general, mood expression, positive or negative, is quite low in posts with @-replies. It is also noted that low activation moods tend to co-occur less frequently with a link, compared to the respective background probability, while high activation moods appear to be relatively more frequently co-occurring with links. Finally, moods co-occurring with @-replies are overall quite infrequent, irrespective of their activation measures. In fact, a large number of moods co-occur with @-replies with a probability much lower than the respective background probability.

Based on these findings, it appears that there is a difference in the manner in which moods are shared in various participation contexts. For link sharing, when links and moods co-occur, those moods tend to be both positive and of moderate to high activation. Replies, on the other hand, show little in the way of mood expression.

### 1.10 Classifying Affective States

From an applications perspective, the foregoing studies provide promising avenues to build mood classifiers useful in search and advertising, or to enable organizations track behavior of populations in health, socio-economics or urban development domains. The following sections described affective state classification embodiments that can be used in these pursuits.

### 1.10.1 Set-up and Training

The classifier is trained on segments of text with known affect. In one tested embodiment this involves employing social media posts (e.g., Twitter™ posts) as the text segments, each of which has a hashtag mood word associated with it that appears in the aforementioned mood words lexicon. The previously described mappings are then used to identify the affect associated with the hashtag mood word for each of the posts being used to train the classifier. However, it is noted that in general any segment of text that evokes a sentiment or emotion can be employed as long as the affect associated with each of the segments is known. For example, the text segments could be from a document and the segments could be sentences. In the following description, the example of employing social media posts as text segments is used. However, it is to be understood that other types of text segments can be used as well.

For each text segment of known effect, word features are extracted. In one tested embodiment, this involves, for each of the aforementioned social media posts being used to train the classifier, converting the text into a form conducive for feature extraction. For example, this conversion can include, any or all of, converting the characters of the post to lowercase, normalizing all numbers into a canonical from, removing any URLs, tokenizing the text, removing non-alphanumeric characters (e.g., commas, apostrophes), and so on. After conversion, word features are extracted from each post to form a vector of word features. In one embodiment, just single words are employed as the word features. In another embodiment, both single words and word pairs are employed as word features. It is noted that the addition of word pairs in the latter embodiment recognizes that in some cases an adjacent word can modify the meaning of a mood word. For example, the mood word “good” might be part of a word pair “not good”. Clearly, the word pair “not good” would correspond to a completely different affect than the single word “good”.

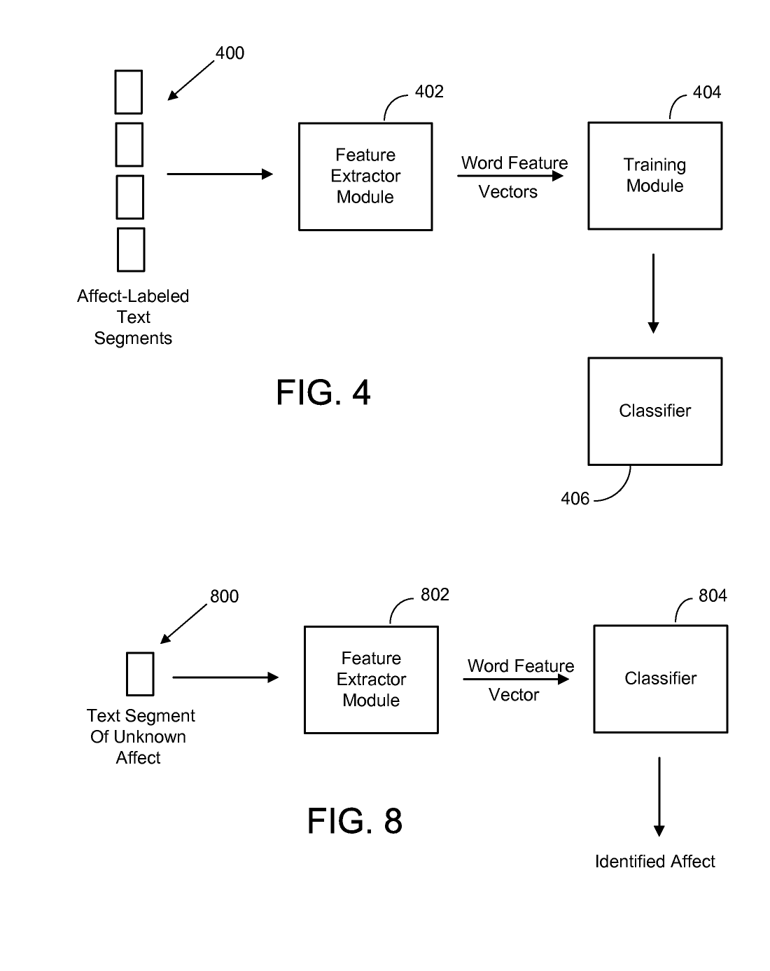

In view of the foregoing, FIG. 4 shows an exemplary computing program architecture for implementing the training of a classifier to identify an affect exhibited by a segment of text. This architecture includes various program modules executable by a computing device (such as one described in the exemplary operating environment section to follow). As can be seen, a plurality of segments of text (400) are input. Each of these segments exhibits a known affect taken from a group of affects as described previously. Word features are extracted from the inputted segments of text (400) via a feature extractor module (402) to produce a vector of word features. Each vector of word features is then fed into a training module (404) which is used to train a classifier (406). As indicated previously, the classifier (406) is trained to identify an affect exhibited by a segment of text input therein. This affect is chosen from a group of affects each of which corresponds to a different emotion or sentiment being expressed by a person authoring the segment of text, where each affect relates more than the valence of the emotion or sentiment being expressed.

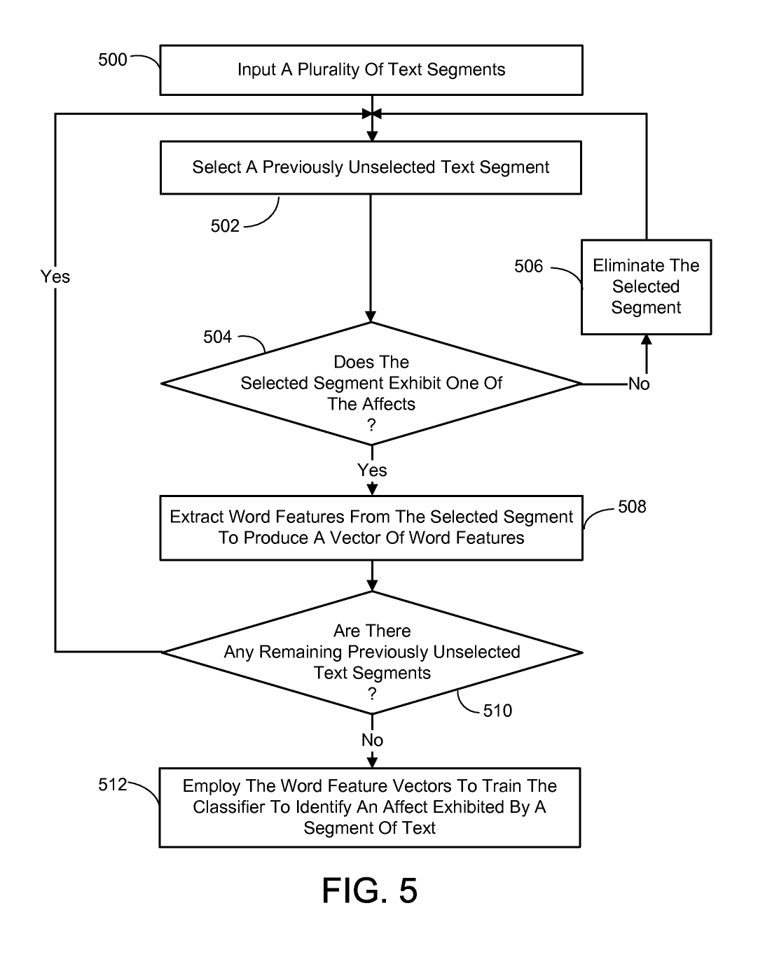

The foregoing computing program architecture can be advantageously used to implement the aforementioned classifier training. More particularly, with reference to FIG. 5, one implementation of a process for training a classifier to identify an affect exhibited by a segment of text, involves first inputting a plurality of segments of text (process action 500). It is noted that not all the inputted text segments are likely to exhibit an affect. Only those that do are processed. To this end, a previously unselected text segment is selected (process action 502), and it is determined if the selected segment exhibits one of the aforementioned affects (process action 504). If the selected segment does not exhibit an affect, it is eliminated (process action 506) and process actions 502 through 506 are repeated, as appropriate. If, however, the selected segment does exhibit an affect, word features are extracted from it to produce a vector of word features (process action 508). It is next determined if there are any remaining previously unselected text segments (process action 510). If there are remaining segments, then process actions 502 through 510 are repeated. If not, then the word feature vectors are employed to train the classifier to identify an affect exhibited by a segment of text (process action 512).

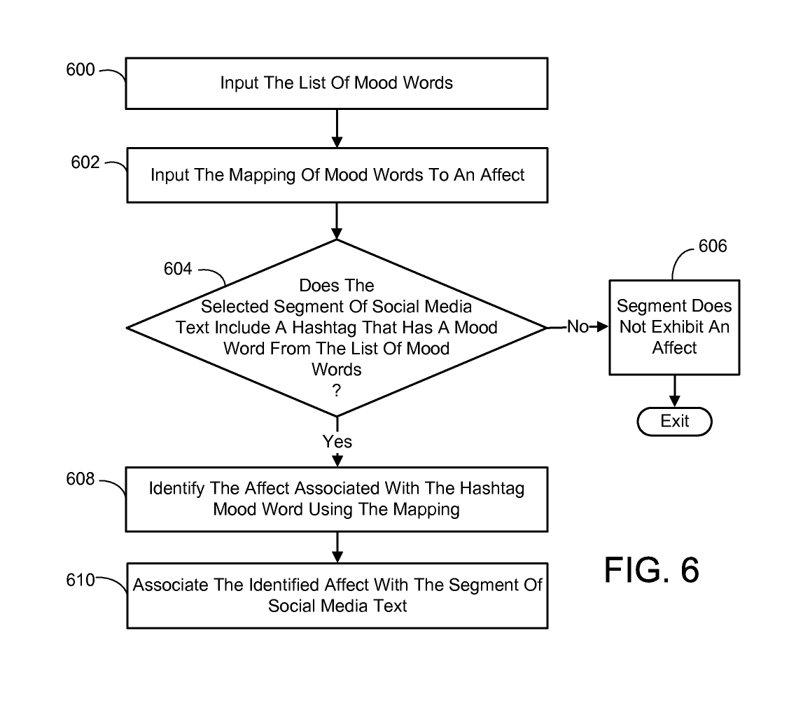

With regard to the foregoing process action of determining if the selected segment exhibits one of the aforementioned affects, FIG. 6 shows one implementation for accomplishing this task when the text segments are segments of social media text (e.g., a post) having a hashtag that includes a mood word found on the previously-described list of mood words. More particularly, a list of mood words is input (process action 600), along with a mapping of each mood word from the list to an affect (process action 602). It is next determined whether the selected segment of social media text includes a hashtag that has a mood word from the list of mood words (process action 604). If not, then it is deemed the segment does not exhibit an affect (process action 606), and the process ends. Otherwise, the affect associated with the hashtag mood word is identified using the mapping (process action 608), and the identified affect is associated with the segment of social media text (process action 610).

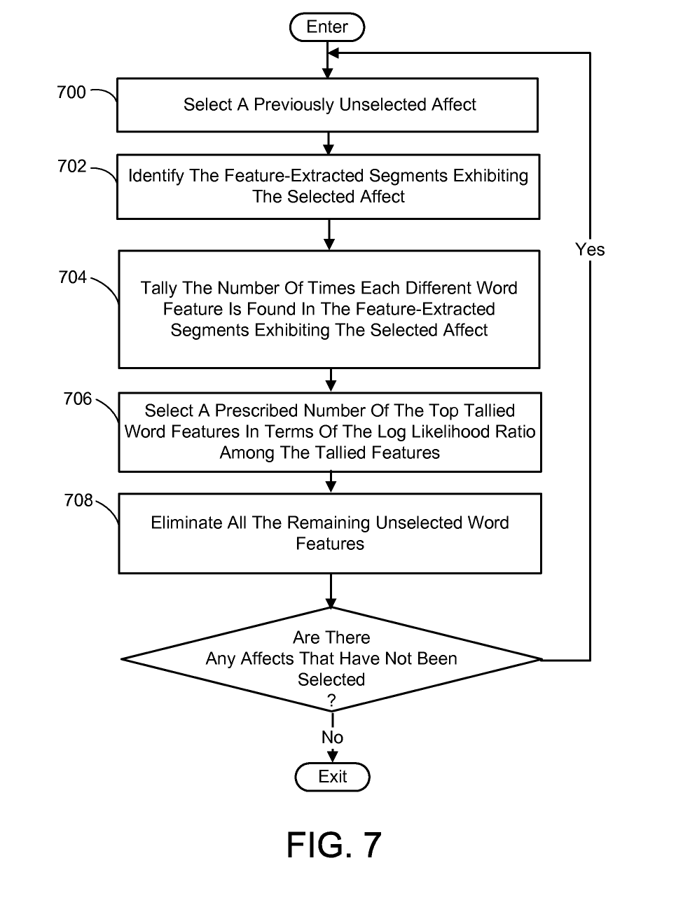

It is noted that after the word features are extracted from the text segments, in one embodiment, prior to using the aforementioned word feature vectors to train the classifier, the number of features in the feature-extracted text segments is reduced to improve the efficiency and accuracy of the classifier training procedure. In one implementation, features that occur fewer than a prescribed number of times (e.g., five) across all the feature-extracted text segments are removed. In another implementation, word features are reduced to a prescribed number (e.g., 50K) of the top features in terms of log likelihood ratio. More particularly, referring to FIG. 7, once word features are extracted from the segments of text of known affect, a previously unselected affect is selected (process action 700), and the feature-extracted segments exhibiting the selected affect are identified (process action 702). The number of times each different word feature is found in the feature-extracted segments exhibiting the selected affect is tallied (process action 704). The aforementioned prescribed number of the top tallied word features in terms of the log likelihood ratio among the tallied word features are selected (process action 706), and all the remaining unselected word features are eliminated (process action 708). It is then determined if there are any affects that have not been selected and processed (process action 710). If so, process actions 700 through 710 are repeated. If not, the process ends.

It is noted that both of the above-described feature reduction implementations can be employed together, or the feature reduction could use just one or the other implementation. In addition, other feature reduction methods can be implemented as well.

Further, in one embodiment, the word feature vectors are randomly split into a prescribed number of folds for cross-validation. In one implementation, the word feature vectors are split into three equal-sized folds, and two of the three folds (i.e., 66.6% of the word feature vectors) are designated as training vectors. The remaining third of the three folds (i.e., 33.3% of the word feature vectors) is designated as testing vectors. The classifier, once trained using the training vectors, is used to predict the affect of each of the testing vectors in a manner to be described shortly, so as to assess its accuracy.

With regard to training, each of the word feature vectors formed from the training segments is operated on by a classification process associated with the classifier being trained. In one embodiment, the classifier is a standard maximum entropy classifier that once trained using the training vectors assigns numerical weights to each word feature of the vector depending on how strongly each is deemed to correlate with the affect associated with the post. The combined weights of all the features in a post are deemed to be indicative of the degree to which it reflects a particular affect. However, other classifiers can be employed as well, such as, without limitation, a support vector machine (SVM) classifier or a naïve Bayes classifier. It is noted that in one tested embodiment, systematic parameter tuning of the classifier was not performed. Rather parameter values were selected based on prior performance on various affect classification tasks.

### 1.10.2 Runtime

At runtime, a new text segment is presented, and word features are extracted from the new text segment using a feature extractor. These are passed into the trained classifier, which looks up the weights for the word features and combines them in a classifier-specific mathematical formulation. The output is a prediction of the affective class of the text segment, and a probability indicative of the likelihood the text segment exhibits the predicted affect.

FIG. 8 shows an exemplary computing program architecture for implementing the classification of an affect in a segment of text. This architecture includes various program modules executable by a computing device (such as one described in the exemplary operating environment section to follow). As can be seen, a segment of text (800) having an unknown affect is input. Word features are extracted from the inputted segment (800) via a feature extractor module (802) to produce a vector of word features. The feature extractor module (802) is similar to the module used to train the classifier. The vector of word features is then fed into the classifier (804). The classifier (804) then identifies an affect exhibited by the inputted segment of text. As before, this affect is chosen from a group of affects each of which corresponds to a different emotion or sentiment being expressed by a person authoring the segment of text, where each affect relates more than the valence of the emotion or sentiment being expressed.

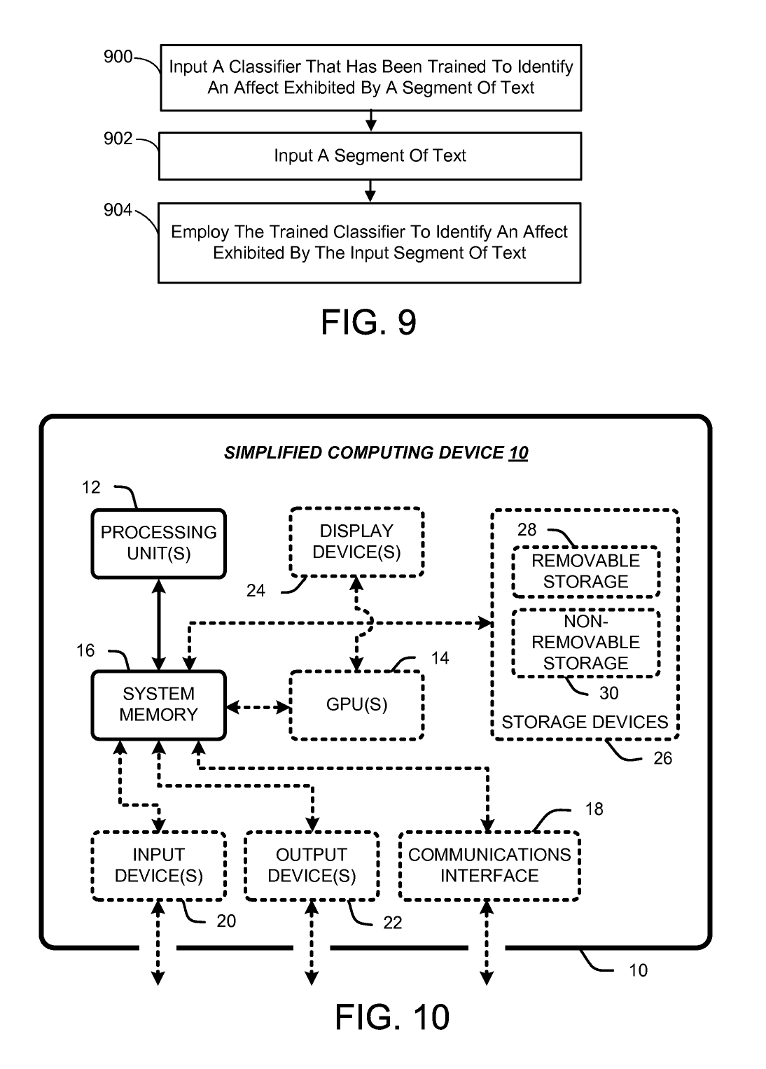

The foregoing computing program architecture can be advantageously used to implement the aforementioned affect classification. More particularly, with reference to FIG. 9, one implementation of a process for classifying an affect in a segment of text, involves first inputting a classifier that has been trained to identify an affect exhibited by a segment of text (process action 900). A segment of text is also input (process action 902). The trained classifier is then employed to identify an affect exhibited by the input segment of text (process action 904).

### 2.0 Exemplary Operating Environments

The affective state classification embodiments described herein are operational within numerous types of general purpose or special purpose computing system environments or configurations. FIG. 10 illustrates a simplified example of a general-purpose computer system on which various embodiments and elements of the affective state classification embodiments, as described herein, may be implemented. It should be noted that any boxes that are represented by broken or dashed lines in FIG. 10 represent alternate embodiments of the simplified computing device, and that any or all of these alternate embodiments, as described below, may be used in combination with other alternate embodiments that are described throughout this document.

For example, FIG. 10 shows a general system diagram showing a simplified computing device 10. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement the affective state classification embodiments described herein, the device should have a sufficient computational capability and system memory to enable basic computational operations. In particular, as illustrated by FIG. 10, the computational capability is generally illustrated by one or more processing unit(s) 12, and may also include one or more GPUs 14, either or both in communication with system memory 16. Note that that the processing unit(s) 12 of the general computing device may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 10 may also include other components, such as, for example, a communications interface 18. The simplified computing device of FIG. 10 may also include one or more conventional computer input devices 20 (e.g., pointing devices, keyboards, audio input devices, video input devices, haptic input devices, devices for receiving wired or wireless data transmissions, etc.). The simplified computing device of FIG. 10 may also include other optional components, such as, for example, one or more conventional display device(s) 24 and other computer output devices 22 (e.g., audio output devices, video output devices, devices for transmitting wired or wireless data transmissions, etc.). Note that typical communications interfaces 18, input devices 20, output devices 22, and storage devices 26 for general-purpose computers are well known to those skilled in the art, and will not be described in detail herein.

The simplified computing device of FIG. 10 may also include a variety of computer readable media. Computer readable media can be any available media that can be accessed by computer 10 via storage devices 26 and includes both volatile and nonvolatile media that is either removable 28 and/or non-removable 30, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Retention of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying some or all of the various affective state classification embodiments described herein, or portions thereof, may be stored, received, transmitted, or read from any desired combination of computer or machine readable media or storage devices and communication media in the form of computer executable instructions or other data structures.

Finally, the affective state classification embodiments described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

### 3.0 Other Embodiments

It is noted that any or all of the aforementioned embodiments throughout the description may be used in any combination desired to form additional hybrid embodiments. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. A computer-implemented process for classifying an affect in a segment of text, comprising:
using a computing device to perform the following process actions:
inputting a classifier that has been trained to identify an affect exhibited by a segment of text, said affect being chosen from a group of affects each of which corresponds to a different emotion or sentiment being expressed by a person authoring the segment of text, wherein each affect in said group of affects relates more than the valence of the emotion or sentiment being expressed;
inputting a segment of text; and
employing the trained classifier to identify an affect exhibited by the input segment of text, said affect being chosen from said group of affects.

2. The process of claim 1, wherein prior to employing the trained classifier to identify an affect exhibited by the input segment of text, performing the process action of extracting features from the input segment to produce a vector of word features.

3. The process of claim 2, wherein the classifier is a maximum entropy classifier, and wherein the process action of employing the trained classifier to identify an affect exhibited by the input segment of text, comprises the actions of:
assigning a prescribed numerical weight to each word feature of the word feature vector input into the classifier; and
combining the assigned weights to produce an overall weight that is indicative of the degree to which the inputted segment of text exhibits an affect from said group of affects.

4. The process of claim 3, wherein the process action of employing the trained classifier to identify an affect exhibited by the input segment of text, further comprises an action of outputting a prediction of the affect that the inputted segment of text exhibits and a probability value indicating the likelihood that inputted segment of text exhibits the predicted affect, based on said overall weight.

5. The process of claim 1, wherein the group of affects comprises at least one of fear, sadness, guilt, hostility, joviality, self-assurance, attentiveness, shyness, fatigue, surprise, and serenity.

6. The process of claim 1, wherein said segment of text is a segment of social media text.

7. The process of claim 1, wherein said word features comprise single words, or single words and word pairs.

8. A computer-readable storage medium having computer-executable instructions stored thereon for training a classifier to identify an affect exhibited by a segment of text, said affect being chosen from a group of affects each of which corresponds to a different emotion or sentiment being expressed by a person authoring the segment of text, wherein each affect in said group of affects relates more than the valence of the emotion or sentiment being expressed, said computer-executable instructions comprising:
inputting a plurality of segments of text;
for each of the segments of text input, identifying an affect exhibited by the segment, if any;
for each of the segments of text identified as exhibiting an affect, extracting features from the segment to produce a vector of word features; and
employing the word feature vectors to train the classifier to identify an affect exhibited by a segment of text.

9. The computer-readable storage medium of claim 8, wherein said inputted segments of text are segments of social media text, and wherein the instruction for identifying an affect, if any, exhibited by said segment of text, comprises instructions for:
inputting a list of mood words;
inputting a mapping of mood words from the list to an affect;
determining whether the input segment of social media text comprises a hashtag that includes a mood word from said list of mood words;
whenever it is determined that the input segment of social media text comprises a hashtag that includes a mood word from said list of mood words, identifying the affect associated with the hashtag mood word using said mapping; and
associating the identified affect with the input segment of social media text.

10. The computer-readable storage medium of claim 8, further comprising, for each inputted segment of text identified as exhibiting an affect, an instruction for converting the segment into a form conducive for feature extraction that is executed prior to executing the instruction for extracting features from the segment.

11. The computer-readable storage medium of claim 8, further comprising an instruction for reducing the number of word features in the feature-extracted segments which is executed prior to executing the instruction for employing said word feature vectors to train the classifier.

12. The computer-readable storage medium of claim 11, wherein the instruction for reducing the number of word features in the feature-extracted segments, comprises an instruction for eliminating word features that occur fewer than a prescribed number of times across the feature-extracted segments.

13. The computer-readable storage medium of claim 11, wherein the instruction for reducing the number of word features in the feature-extracted segments, comprises instructions for:
for each affect in said group of affects,
identifying the feature-extracted segments exhibiting that affect,
tallying the number of times each different word feature is found in the feature-extracted segments exhibiting that affect,
selecting a prescribed number of the top tallied word features in terms of a log likelihood ratio among the tallied word features; and
eliminating all but the selected word features.

14. The computer-readable storage medium of claim 8, wherein said word features comprise single words, or single words and word pairs.

15. The computer-readable storage medium of claim 8, wherein the process action of employing the word feature vectors to train the classifier, comprises the actions of:
randomly splitting the word feature vectors into equal groups;
employing all but one of the groups of word feature vectors to train the classifier to identify an affect exhibited by a segment of text; and
employing the remaining group of word feature vectors not used to train the classifier to assess the accuracy of the classifier by inputting each of the word feature vectors of the remaining group into the classifier and determining for each inputted word feature vector whether the classifier accurately identifies the affect known to be exhibited by that the text segment associated with that word feature vector.

16. A system for training a classifier to identify an affect exhibited by a segment of text, comprising:
a computing device; and
a computer program having program modules executable by the computing device, the computing device being directed by the program modules of the computer program to,
input a plurality of segments of text, each of which exhibits a known affect from a group of affects;
for each of the inputted segments of text, extracting features from the segment to produce a vector of word features;
employ a training module to train a classifier using the word feature vectors to identify an affect exhibited by a segment of text, said affect being chosen from a group of affects each of which corresponds to a different emotion or sentiment being expressed by a person authoring the segment of text, wherein each affect in said group of affects relates more than the valence of the emotion or sentiment being expressed.

17. The system of claim 16, wherein the classifier is a maximum entropy classifier.

18. The system of claim 16, wherein the group of affects comprises at least one of fear, sadness, guilt, hostility, joviality, self-assurance, attentiveness, shyness, fatigue, surprise, and serenity.

19. The system of claim 16, wherein said inputted segments of text are segments of social media text.

20. The system of claim 16, wherein said word features comprise single words, or single words and word pairs.
